(19) United States
(12) Patent Application Publication
(10) Pub. No.: US 2012/0200422 A1
(43) Pub. Date: Aug. 9, 2012

(54) Use of Digital Transport Delay to Improve Measurement Fidelity in Swept-Wavelength Systems

(75) Inventors: Roger Glen Duncan, Christiansburg, VA (US); Brooks A. Childers, Christiansburg, VA (US)

(73) Assignee: BAKER HUGHES INCORPORATED, Houston, TX (US)

(21) Appl. No.: 13/023,945

(22) Filed: Feb. 9, 2011

(51) Int. Cl. G01V 3/00

(52) U.S. Cl. 340/854.7

(57) ABSTRACT

A method and apparatus for obtaining a parameter of interest from an optical device placed along a fiber optic cable in a wellbore is disclosed. Light is propagated a light through the fiber optic cable from a light source. A first detector receives a first signal responsive to interaction of the propagated light and the optical device, wherein the first signal has a delay. A second detector receives a second signal and a digital delay device delays the received second signal. A sampling device obtains a selected signal from the first signal using the delayed second signal, and a processor determines the parameter of interest using the selected signal.

### BACKGROUND OF THE DISCLOSURE

1. Field of the Disclosure

The present disclosure relates to obtaining a parameter of interest at a member used in a wellbore for oil exploration and production.

2. Description of the Related Art

In various aspects of oil exploration and production, tubulars or other members are disposed in a wellbore at a considerable distance from operating and testing machinery, which are generally located at a surface location. In one method of obtaining a parameter of interest related to the tubular or member, optical sensors are deployed downhole and a light source at a surface location supplies light to the optical sensors over a fiber optic cable. Interaction of the propagated light with the optical sensors produces a first signal that is subsequently received at the surface location. A second signal (trigger signal) is used at the surface location to select a signal from the received first signals that is used to obtain the parameter of interest. If the propagated light sweeps across a range of wavelengths, such as in swept-wavelength interferometry, synchronization between the first and second signals is important, requiring in one aspect that the first and second signals experience the same optical delay. However, the optical path length of the first signal (typically 10 kilometers or more in oil exploration and production) is long in comparison to that of the second signal (generally a few meters or less), so these signals are generally not synchronized. Current methods for compensating for the differences in optical path length require introducing fiber optic cable and/or optical switches into the path of the trigger beam. These methods are often cumbersome and space-consuming and can produce signal loss. The present disclosure provides a method and apparatus for obtaining signals in swept-wavelength interferometry system using a digital delay.

### SUMMARY OF THE DISCLOSURE

In one aspect, the present disclosure provides a method of obtaining a parameter of interest from an optical device placed along a fiber optic cable in a wellbore, the method including: propagating a light through the fiber optic cable from a light source; receiving a first signal responsive to interaction of the propagated light and the optical device, the first signal having a delay; receiving a second signal; delaying the received second signal using a digital delay; obtaining a selected signal from the first signal using the delayed second signal; and determining the parameter of interest using the selected signal.

In another aspect, the present disclosure provides an apparatus for obtaining a parameter of interest from an optical device in a wellbore, the apparatus including a fiber optic cable having the optical device therein; a light source configured to propagate a light through the fiber optic cable; a first detector configured to receive a first signal responsive to interaction of the propagated light and the optical device, the first signal having a delay; a second detector configured to receive a second signal; a digital delay device configured to delay the received second signal; a sampling device configured to obtain a selected signal from the first signal using the delayed second signal; and a processor configured to determine the parameter of interest using the selected signal.

Examples of certain features of the apparatus and method disclosed herein are summarized rather broadly in order that the detailed description thereof that follows may be better understood. There are, of course, additional features of the apparatus and method disclosed hereinafter that will form the subject of the claims.

### BRIEF DESCRIPTION OF THE DRAWINGS

For detailed understanding of the present disclosure, references should be made to the following detailed description of the preferred embodiment, taken in conjunction with the accompanying drawings, in which like elements have been given like numerals and wherein:

FIG. 1 shows an exemplary oil production system suitable for use with the exemplary methods and optical systems described herein;

FIG. 2 shows an exemplary optical system for obtaining a parameter of interest from the exemplary system of FIG. 1;

FIG. 3 shows an alternate embodiment of an optical system for obtaining a parameter of interest from the exemplary system of FIG. 1;

FIG. 4 shows an exemplary embodiment of a memory device for providing a digital time delay to exemplary digitized trigger signals such as used in exemplary optical systems of FIGS. 2 and 3; and

FIG. 5 illustrates a method of obtaining signals related to various sensors at a plurality of locations within the exemplary oil production system of FIG. 1.

### DETAILED DESCRIPTION OF THE DISCLOSURE

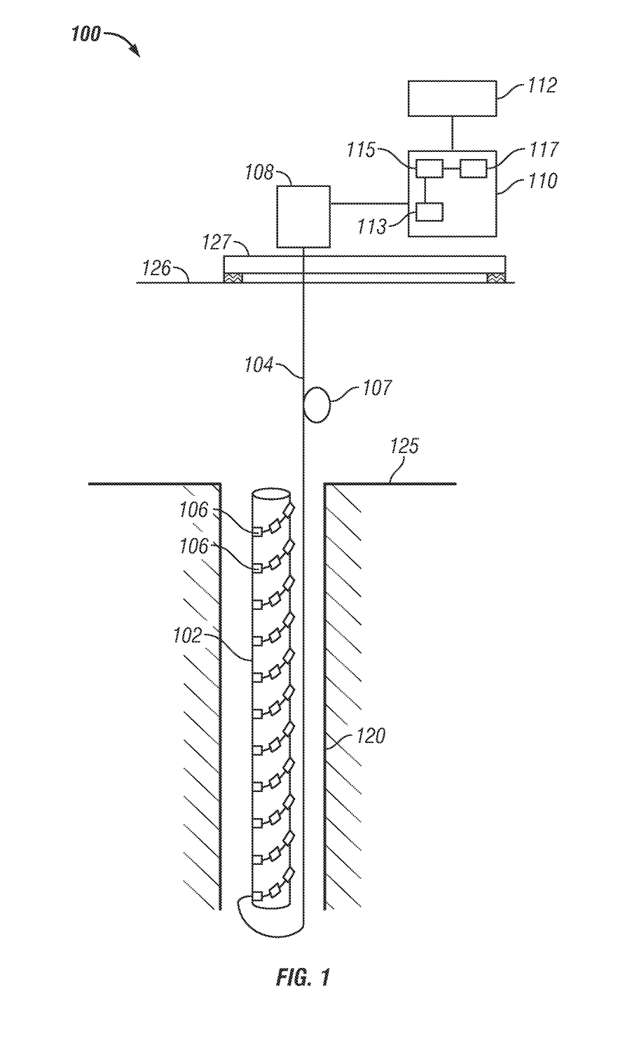

FIG. 1 shows an exemplary oil production system 100 suitable for use with the exemplary methods and optical system described herein. The exemplary production system 100 of FIG. 1 includes a tubular 102 in wellbore 120 in optical communication with surface electronics via fiber optic cable 104. Fiber optic cable 104 includes a plurality of sensors 106. Each of the plurality of sensors 106 is configured to provide an optical signal upon interaction with a light propagating in the fiber optic cable 104. The optical fiber 104 is wrapped around the surface of the tubular 102 and each of the plurality of sensors 106 is thereby attached at a particular location to tubular 102. A change in a parameter of the tubular, such as strain or temperature, at the particular location is therefore detected by the sensor attached at or near the particular location, which thus provides a signal corresponding to the detected change in parameter. These signals may be processed at surface electronics to obtain a result such as, for example, a strain, a temperature or a deformation of the tubular. Therefore, the fiber optic cable and sensors may be used, for example, in various methods such as Real Time Compaction Monitoring (RTCM), Distributed Temperature Sensing (DTS), optical frequency domain reflectometry (OFDR), or any applicable methods using swept-wavelength interferometry.

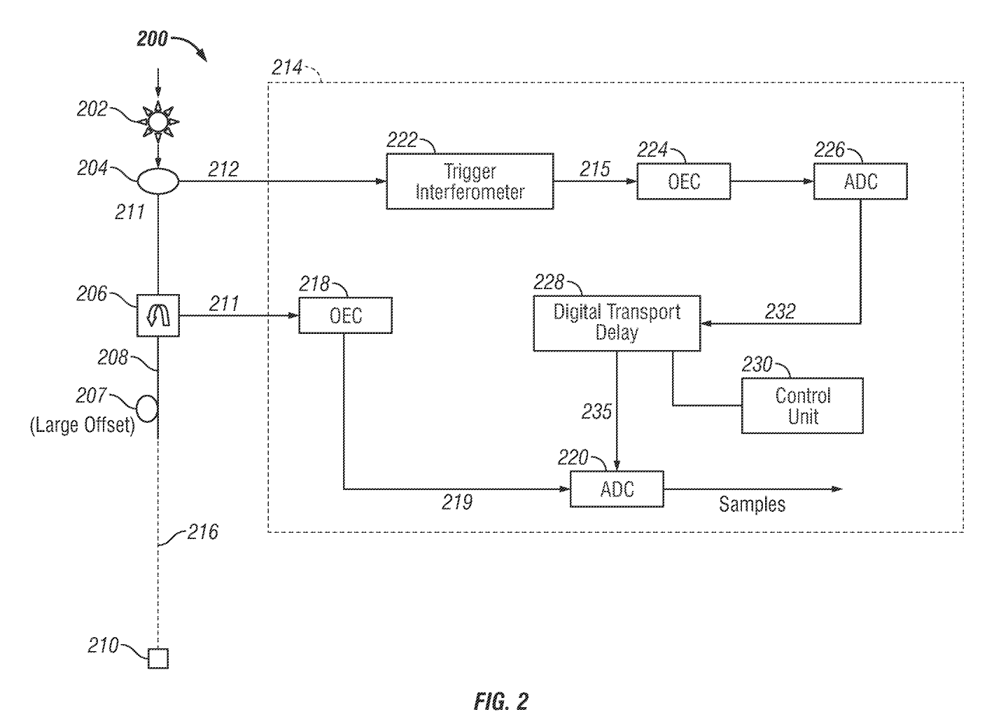

Fiber optic cable 104 is coupled at the surface location to an interrogation unit 108. The interrogation unit 108 may include a light source (not shown), typically a tunable laser for providing light to the sensors via fiber optic cable 104, and circuitry for obtaining signals from light received from the plurality of sensors 106. Various details of the interrogation unit are described in reference to FIG. 2. Interrogation unit 108 may be coupled to a data processing unit 110 and in one aspect transmits obtained signals to the data processing unit. In one aspect, the data processing unit 110 receives and processes the measured signals from the interrogation unit 108 to obtain a parameter, such as a measurement of wavelength, strain or temperature at the tubular. In various aspects, data processing unit 110 includes at least one memory 115 having various programs and data stored therein, a computer or processor 113 accessible to the memory and configured to access one or more of the programs and/or data stored therein to obtain the parameter, and a recording medium 117 for recording and storing the obtained parameter. The data processing unit 110 may output the parameter to various devices, such as a display 112 or the recording medium 117.

The exemplary production system 100 of FIG. 1 is a sub-sea oil production system including sensors at a tubular 102 at a sea bottom location 125 in communication with surface electronics (i.e., interrogation unit 108) located at a sea platform 127 at sea level 126. However, FIG. 1 is provided only as an illustration and not as a limitation of the present disclosure. The system may alternately be deployed at a land location and may include an oil exploration system, an oil production system, a measurement-while-drilling tool, or a wireline logging device, among others. In addition, the system may be suitable for use with any member used in an application. Although not a limitation of the disclosure, an exemplary system suitable for using the methods and optical system disclosed herein are often characterized by a large separation distance between light/surface electronics and a member. A typical separation distance may be 1 km or more.

The path a light takes to travel from a first place to a second place is known as an optical path. The distance traveled over an optical path is an optical path length or optical delay. In exemplary system 100, due to the distance between light source/surface electronics and sensors, the optical delay for light along this optical path is considerable. For a 10 km optical path length, a delay on the order of 100 microseconds is typical. The optical delay for the path between source/electronics and downhole member, as illustrated in the exemplary embodiment of FIG. 1, is represented by optical delay 107 which is shown in fiber optic cable 106.

FIG. 2 shows an exemplary optical system 200 for obtaining a signal related to a parameter of interest of the exemplary system of FIG. 1. The exemplary optical system is a swept-wavelength system that includes a light source 202, fiber optic cable 208 including a plurality of sensors 216 formed therein, and various optical and electrical devices generally referred to herein as surface electronics 214. In an exemplary embodiment, the one or more sensors 216 are Fiber-Bragg Gratings. An FBG is a periodic change in the refractive index of the core of an optical fiber and is typically created using a laser etching process. Such a grating reflects a percentage of incoming light, but only at a specific wavelength known as the Bragg wavelength, which is directly related to the grating period. Stresses or environmental factors, such as thermal changes or mechanical stress, affect the grating period and therefore produce changes in the Bragg wavelength. Thus, an operator observing a wavelength of reflected light from an FBG can determine a relevant measurement, i.e., temperature, strain, etc.

Fiber optic cable 208 also includes a reference reflector 210 at a distal end of the fiber optic cable. Fiber optic cable is therefore configured to propagate light from the circulator 206 toward reference reflector 210 and propagate reflected light towards the circulator. The reflected light may be reflected by any of the one or more sensors 216 or by the reference reflector 210. Reference reflector 210 provide a reference signal which, when combined with a reflected light from a particular sensor of the sensor array, produces an interference pattern (beat frequency) which may be used to identify an obtained signal with the particular sensor.

Typically, in order to determine the Bragg wavelength for a selected sensor, light source 202 sweeps across a range of wavelengths. The exemplary light source 202 may be a tunable light source or a swept-wavelength light source that provides a light beam that sweeps across a selected range of wavelengths at a selected rate. In various aspects, the light source may be a continuous light source, such as a tunable laser, or a broadband light source having a filter configured to sweep a range of wavelengths. The range of frequencies and the sweep rate may be pre-programmed or provided by a processor running software or by an operator. The selected range of wavelengths of light source 202 generally corresponds to an expected wavelength response range of the plurality of sensors 216. A typical range of wavelengths may be from 1550 nanometers (nm) to 1650 nm at a typical sweep rate of 100 nm per second. For various reasons, a tunable light source tends not to sweep the selected range in a constant linear manner but instead sweeps the range in non-uniform non-linear manner.

In the exemplary system 200, beam splitter 204 splits light from light source 202 into a first beam of light 211 and a second beam of light 212. The first beam of light is propagated along fiber optic cable 208. Circulator 206 provides the first beam of light 211 to fiber optic cable 208 and provides light returning from the fiber optic cable to surface electronics 214. Beam splitter 204 splits light at a ratio that can be selected by an operator.

First beam of light 211 returning from downhole includes a signal from the sensors in response to the propagated light in the fiber optic cable and is received at surface electronics 214. First beam of light 211 is received at detector (optical-electrical converter (OEC)) 218 which may be any type of device for converting optical signals to electrical signal including a detector, photodetector or charge-coupled device, for example. Detector 218, in one aspect, produces an electrical signal 219 having a waveform related to the received first beam light 211 and sends the electrical signal 219 to sampler (analog-to-digital converter (ADC)) 220 for sampling.

Second beam 212 provides a second signal and may be received at surface electronics 214 at trigger interferometer 222 which produces a trigger signal 215 corresponding to the second beam 212. Typically, the trigger signal may be created using a negative-to-positive zero-crossing of the light at an interference fringe pattern formed from second beam 212 at the trigger interferometer. Alternatively, a trigger signal may be created using a positive-to-negative zero-crossing at the interference fringe pattern. Detector (optical-electrical converter (OEC)) 224 converts trigger signal 215 from an optical signal to an electrical signal. Analog-to-digital converter (ADC) 226 then digitizes the electrical signal. The digitized trigger signal 232 is sent to digital transport delay device 228.

One characteristic of the exemplary system of the present disclosure is the comparatively long optical path length of the first beam with respect to the optical path length of the second beam. Additional optical fiber representing this long optical path length is indicated by loop 207 of fiber optic cable 208. For deep-sea oil exploration and production, the optical path length of the first beam 211 is typically greater than 1 kilometer and may be in the range of 10 km-30 km. In contrast, a trigger beam travels along an optical path length which is typically a few meters or less. Due to the difference in the optical path lengths, the second beam 212 arrives at surface electronics 214 “ahead” of the first beam 211, leading to synchronization issues between trigger signal 232 and electrical signal 219.

Digital transport delay device 228 adds a time delay to digital trigger signal 232 through electrical means that may include digital means or computational means. The added time delay, referred to herein as a digital delay, can in one embodiment be substantially the same as the optical delay experienced by first beam 212 in traversing the optical path length provided by fiber optic cable 208. Delayed trigger signal 235, which is the digital trigger signal 232 delayed by the digital delay provided by the digital transport delay device 228, is therefore synchronized with electrical signal 219. Sampling device (Analog Digital Converter (ADC)) 220 uses delayed trigger signal 235 to trigger a sampling (frequency sampling) of the electrical signal 219 to thereby produce a selected signal, which may be identified with a particular sensor. The sampled signal may be used to obtain a parameter of interest.

In one aspect, digital transport delay device 228 is coupled to control unit 230, which may be a processor running a software program or a user interface allowing operator control. The control unit 230 may select a particular delay for the digital transport delay device 228, thereby selecting a particular optical path length corresponding to a particular sensor. A delay may be selected to obtain samples from a subset of the plurality of sensors, for example a set of sensors at a selected location of tubular 102 (FIG. 1).

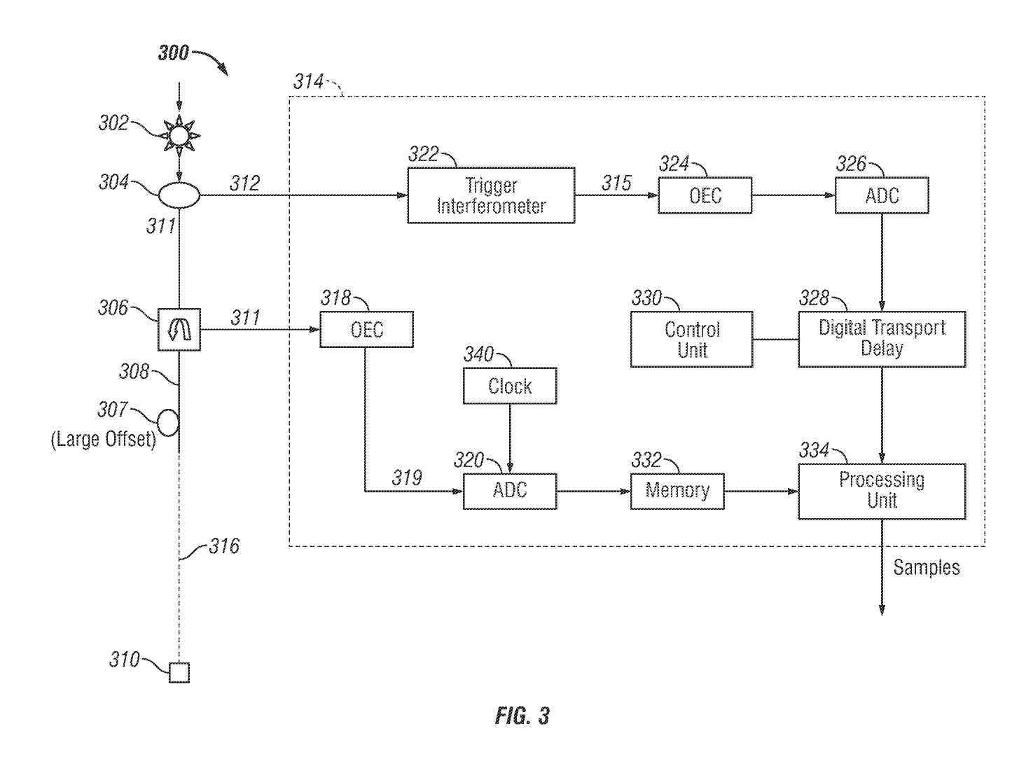

FIG. 3 shows an alternate embodiment of a swept-wavelength system 300 for obtaining a parameter of interest from the exemplary system of FIG. 1. The alternate embodiment includes a light source 302, fiber optic cable 308 including a plurality of sensors 316 formed therein, and various optical and electrical devices generally referred to herein as surface electronics 314.

In the exemplary alternate embodiment of FIG. 3, light is transmitted from the light source 302 to beam splitter 304 which splits light from light source 302 into a first beam of light 311 and a second beam of light 312. The first beam of light is propagated along fiber optic cable 308. Circulator 306 provides the first beam of light 311 to fiber optic cable 308 and provides light returning from the fiber optic cable to surface electronics 314. Beam splitter 304 splits light at a ratio that can be selected by an operator. Fiber optic cable 308 also includes a reference reflector 310 at a one end of the fiber optic cable. Light may be reflected by any of the one or more sensors 316 or by reference reflector 310. Reference reflector 310 provide a reference signal which, when combined with a reflected light from a particular sensor of the sensor array, produces an interference pattern (beat frequency) which may be used to identify an obtained signal with the particular sensor.

First beam 311 returning from fiber optic cable 308 is received at surface electronics 314 at detector (optical-electrical converter (OEC)) 318. Detector 318, in one aspect, produces an electrical signal 319 having a waveform related to returning first beam 311. Detector 318 transmits electrical signal 319 to sampler (analog-to-digital converter (ADC)) 320 for sampling. In one aspect, a time-synchronous trigger device such as clock 340 provides a signal to sampler 320 to activate sampling of electrical signal 319 to produces time-synchronous samples. Time-synchronous samples may be stored to a memory location 338 for future processing. Alternatively, time-synchronous samples may be sent directly to processor unit 340 for immediate processing.

Second beam 312 is received at trigger interferometer 322 which produces a trigger signal 315 corresponding to the second beam 312. Detector (optical-electrical converter (OEC)) 324 converts optical trigger signal 315 to an electrical trigger signal. Analog-to-digital converter 326 digitizes the electrical trigger signal to produce a digitized signal 332 which is sent to a digital transport delay device 328.

Digital transport delay device 328 adds a time delay to digital trigger signal 332 similar in FIG. 2. Delayed trigger signal 335, which is the digital trigger signal 232 delayed by the digital delay provided by the digital transport delay device 328, is usable at processor 334 for determining signal responses of the various sensors of 316. In one aspect, digital transport delay device 228 is coupled to control unit 330, which may be a processor running a software program or a user interface allowing operator control. The control unit 330 may select a particular delay time for use at the digital transport delay device 328, thereby enabling selecting a particular optical path length corresponding to a particular sensor. Alternatively, multiple delay times may be applied at digital transport delay device 328 to select various sensors locations as discussed with respect to FIG. 5, below.

Processing unit 326 is coupled to the digital transport delay 328 having the digitally-delayed trigger signals and memory 338 having sampled signals. Processor 326 receives samples directly from sampler 320 or from memory location 324 and applies the combined trigger signal and digital delay to obtain a signal. In one embodiment, processor may use signal 335 to obtain signals from time-synchronous samples, the obtained signals being linear in wavelength.

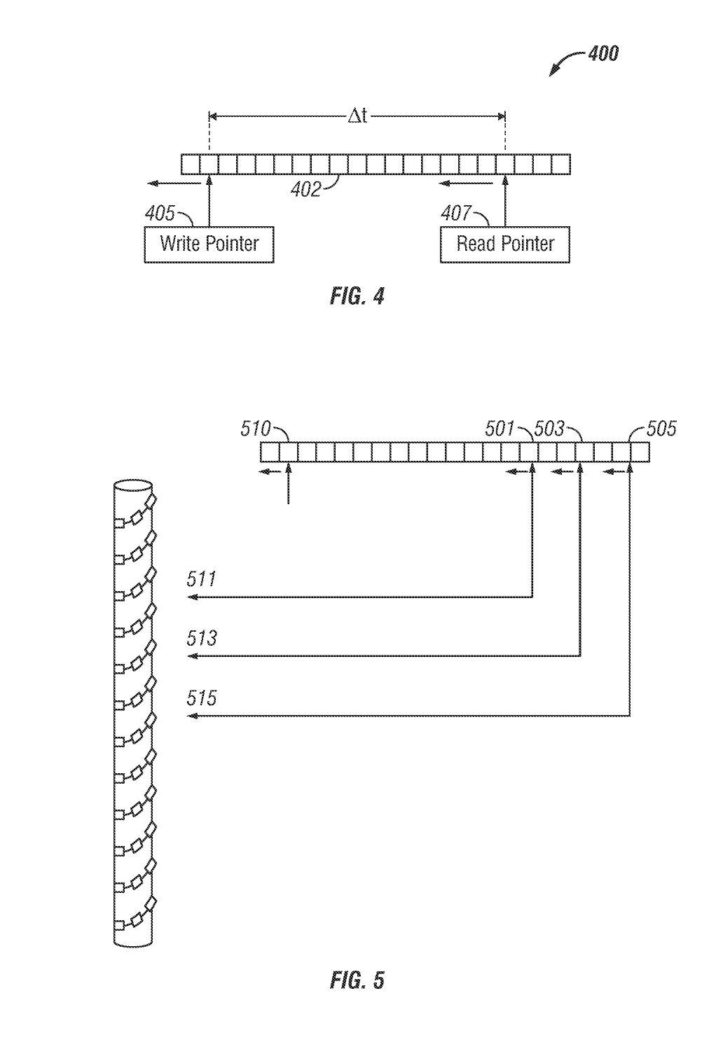

FIG. 4 shows an exemplary embodiment of a memory device for providing a digital time delay to exemplary digitized trigger signals such as used in exemplary optical systems of FIGS. 2 and 3. The exemplary memory device 400 includes a plurality of memory locations 402, a write pointer 405 and a read pointer 407. A pointer is a data type whose value refers directly to (or “points to”) another value stored elsewhere in the computer memory using its address. In the exemplary embodiment of FIG. 4, the memory device 400 is a linear memory buffer. A circular buffer or other memory type may also be used. The memory locations 402 may be used to store exemplary digital trigger signals 232, 332. Write pointer is used to store the exemplary digital trigger signals in memory. Read pointer reads the trigger signal from the memory location 402 at a selected delay time (Δt) after the trigger signal has been written. In one embodiment, the delay time is equivalent to the optical delay of the first beam, as discussed above. A software program or an operator having access to the read and write pointers can select a particular delay time. Given a shift speed of the pointers, the delay time can be represented by a difference in memory addresses between the read pointer and the write pointer. In an exemplary embodiment, the shift register may be 10-100 times faster than an average trigger rate. This speed ensures a granularity/resolution with respect to the output trigger. The size of the memory buffer is selected to handle parameters of the signal (i.e., large delay/clock period). For a 10 km round trip of the first beam (corresponding to about 100 microsecond delay) and a sampling resolution of 1 nanosecond, a memory buffer size of 100K is suitable.

FIG. 5 illustrates a method of obtaining signals related to various sensors at a plurality of locations within the exemplary oil production system of FIG. 1. Memory locations are shown with a write pointer 510 and a plurality of read pointers 501, 503 and 507. The delay time of the plurality of read pointers with respect to the write pointer may be selected by various means including via methods described in relation to control unit 330. The delay time between a selected read pointer and the write pointer may correspond to a particular sensor or cluster of sensors at the tubular. Thus, selecting the delay time enables an operator to specify a region of the tubular for obtaining signals. In FIG. 5, read pointer 501 selects sensors in the region indicated by arrow 511, read pointer 503 selects sensors in the region indicated by arrow 513, and read pointer 505 selects sensors in the region indicated by arrow 515.

Therefore, in one aspect, the present disclosure provides a method of obtaining a parameter of interest from an optical device placed along a fiber optic cable in a wellbore, the method including: propagating a light through the fiber optic cable from a light source; receiving a first signal responsive to interaction of the propagated light and the optical device, the first signal having a delay; receiving a second signal; delaying the received second signal using a digital delay; obtaining a selected signal from the first signal using the delayed second signal; and determining the parameter of interest using the selected signal. In one aspect, the method sampling the first signal using the delayed second signal to obtain the selected signal. The second signal may be a signal from the light source. The received second signal may be a trigger signal based on a zero-crossing related to light from the light source. The digital delay can be selected to be substantially equal to the delay of the first signal. The first signal can include time-synchronous signals. Delaying the received second signal can include writing the second signal to a memory location and reading the second signal from the memory location at a selected time after writing the second signal. In various embodiments, the parameter of interest is one of a: (i) strain at a member in the wellbore; (ii) temperature; and (iii) deformation of a member in the wellbore. The light may be propagated such that a wavelength of the propagated light sweeps across a range of wavelengths in a selected time.

In another aspect, the present disclosure provides an apparatus for obtaining a parameter of interest from an optical device in a wellbore, the apparatus including a fiber optic cable having the optical device therein; a light source configured to propagate a light through the fiber optic cable; a first detector configured to receive a first signal responsive to interaction of the propagated light and the optical device, the first signal having a delay; a second detector configured to receive a second signal; a digital delay device configured to delay the received second signal; a sampling device configured to obtain a selected signal from the first signal using the delayed second signal; and a processor configured to determine the parameter of interest using the selected signal. The sampling device can be configured to sample the first signal using the delayed second signal. The second signal may be a signal from the light source. The second signal may be a trigger signal based on a zero-crossing related to light from the light source. The digital delay device in one embodiment is configured to delay the second signal by a time duration substantially equal to the delay of the first signal. The first signal may include time-synchronous signals. The digital delay device may be configured to delay the received second signal by writing the second signal to a memory location and reading the second signal from the memory location a selected time after writing the second signal. The parameter of interest may be one of a: (i) strain at a member in the wellbore; (ii) temperature; and (iii) deformation of a member in the wellbore. In one embodiment, the light source is configured to propagate light at a wavelength that sweeps across a range of wavelengths in a selected time.

While the foregoing disclosure is directed to the preferred embodiments of the disclosure, various modifications will be apparent to those skilled in the art. It is intended that all variations within the scope and spirit of the appended claims be embraced by the foregoing disclosure.

What is claimed is:

1. A method of obtaining a parameter of interest from an optical device placed along a fiber optic cable in a wellbore, comprising:
propagating a light through the fiber optic cable from a light source;
receiving a first signal responsive to interaction of the propagated light and the optical device, the first signal having a delay;
receiving a second signal;
delaying the received second signal using a digital delay;
obtaining a selected signal from the first signal using the delayed second signal; and
determining the parameter of interest using the selected signal.

2. The method of claim 1, wherein obtaining the selected signal further comprises sampling the first signal using the delayed second signal.

3. The method of claim 1, wherein the second signal is a signal from the light source.

4. The method of claim 1, wherein the received second signal is a trigger signal based on a zero-crossing related to light from the light source.

5. The method of claim 1, wherein the digital delay is selected to be substantially equal to the delay of the first signal.

6. The method of claim 1, wherein the first signal includes time-synchronous signals.

7. The method of claim 1, wherein delaying the received second signal further comprises writing the second signal to a memory location and reading the second signal from the memory location at a selected time after writing the second signal.

8. The method of claim 1, wherein the parameter of interest is one of a: (i) strain at a member in the wellbore; (ii) temperature; and (iii) deformation of a member in the wellbore.

9. The method of claim 1, wherein a wavelength of the propagated light sweeps across a range of wavelengths in a selected time.

10. An apparatus for obtaining a parameter of interest from an optical device in a wellbore, comprising:
a fiber optic cable having the optical device therein;
a light source configured to propagate a light through the fiber optic cable;
a first detector configured to receive a first signal responsive to interaction of the propagated light and the optical device, the first signal having a delay;
a second detector configured to receive a second signal;
a digital delay device configured to delay the received second signal;
a sampling device configured to obtain a selected signal from the first signal using the delayed second signal; and
a processor configured to determine the parameter of interest using the selected signal.

11. The apparatus of claim 10, where the sampling device is configured to sample the first signal using the delayed second signal.

12. The apparatus of claim 10, wherein the second signal is a signal from the light source.

13. The apparatus of claim 10, wherein the second signal is a trigger signal based on a zero-crossing related to light from the light source.

14. The apparatus of claim 10, wherein the digital delay device is configured to delay the second signal by a time duration substantially equal to the delay of the first signal.

15. The apparatus of claim 10, wherein the first signal includes time-synchronous signals.

16. The apparatus of claim 10, wherein the digital delay device is configured to delay the received second signal by writing the second signal to a memory location and reading the second signal from the memory location a selected time after writing the second signal.

17. The apparatus of claim 10, wherein the parameter of interest is one of a: (i) strain at a member in the wellbore; (ii) temperature; and (iii) deformation of a member in the wellbore.

18. The apparatus of claim 10, wherein the light source is configured to propagate light at a wavelength that sweeps across a range of wavelengths in a selected time.
